(19) United States
(12) Patent Application Publication
(10) Pub. No.: US 2026/0301770 A1
(43) Pub. Date: Oct. 1, 2026

(54) VIDEO PROCESSING METHOD AND APPARATUS, DEVICE, AND STORAGE MEDIUM

(71) Applicant: Beijing Zitiao Network Technology Co., Ltd., Beijing (CN)

(72) Inventors: Xiaowei LI, Beijing (CN); Xuwei CHEN, Beijing (CN); Chenyu XIANG, Beijing (CN)

(21) Appl. No.: 19/575,857

(22) Filed: Mar. 23, 2026

(30) Foreign Application Priority Data
Mar. 25, 2025 (CN) 202510363139.0

(51) Int. Cl. G11B 27/031; G06F 3/0484; G06T 5/70; G06T 11/23

(52) U.S. Cl. CPC G11B 27/031; G06F 3/0484; G06T 5/70; G06T 11/23; G06T 2200/24; G06T 2207/10016

(57) ABSTRACT

The present disclosure provides a video processing method and apparatus, a device, and a storage medium. The method includes: determining a subtitle dynamic effect corresponding to a first video, where the subtitle dynamic effect has a dynamic effect protocol file for characterizing dynamic effect feature information of the subtitle dynamic effect, and the first video includes an audio segment and a subtitle text segment having a correspondence with the audio segment; generating a subtitle material segment for presenting the subtitle text segment with the subtitle dynamic effect according to the dynamic effect protocol file and the subtitle text segment; and generating a second video including video content of the first video that presents a subtitle text with the subtitle dynamic effect based on the subtitle material segment and the audio segment.

### CROSS-REFERENCE TO RELATED APPLICATION

The present application claims the priority to Chinese Patent Application No. 202510363139.0, filed on Mar. 25, 2025, the entire disclosure of which is incorporated herein by reference as portion of the present application.

### TECHNICAL FIELD

The present disclosure relates to a video processing method and apparatus, a device, and a storage medium.

### BACKGROUND

At present, in the art of video processing, a user may manually edit a subtitle in a video, for example, add different effects (such as a font, a font size, an animation effect, and a sticker) to the subtitle according to a subtitle dynamic effect to complete the editing processing of the subtitle.

However, manually adding effects to the video subtitle often takes a long time, and the efficiency is low.

### SUMMARY

In order to solve the above problem, embodiments of the present disclosure provide a video processing method and apparatus, a device, and a storage medium.

The present disclosure provides a video processing method, including:

determining a subtitle dynamic effect corresponding to a first video, where the subtitle dynamic effect has a corresponding dynamic effect protocol file, the dynamic effect protocol file is used to characterize dynamic effect feature information of the subtitle dynamic effect, and the first video includes an audio segment and a subtitle text segment having a correspondence with the audio segment;

generating a subtitle material segment according to the dynamic effect protocol file corresponding to the subtitle dynamic effect and the subtitle text segment, where the subtitle material segment is used to present the subtitle text segment with the subtitle dynamic effect; and

generating a second video corresponding to the first video based on the subtitle material segment and the audio segment.

In an optional implementation, after the generating the second video corresponding to the first video based on the subtitle material segment and the audio segment, the method further includes:

displaying the second video in a video preview window of a track editing interface, where the second video presents subtitle content with the subtitle dynamic effect.

In an optional implementation, the method further includes:

displaying the subtitle material segment on a subtitle track of the track editing interface.

In an optional implementation, the displaying the subtitle material segment on the subtitle track of the track editing interface includes:

displaying the subtitle material segment on the subtitle track of the track editing interface based on a subtitle effect description segment corresponding to the subtitle material segment, where the subtitle effect description segment is generated for the subtitle text segment corresponding to the subtitle material segment based on the dynamic effect protocol file.

In an optional implementation, the dynamic effect protocol file defines a dynamic effect element included in the subtitle dynamic effect and display parameter information corresponding to the dynamic effect element, and the subtitle effect description segment is generated for the corresponding subtitle text segment based on the dynamic effect element defined in the dynamic effect protocol file and the display parameter information corresponding to the dynamic effect element defined in the dynamic effect protocol file.

In an optional implementation, before the displaying the subtitle material segment on the subtitle track of the track editing interface based on the subtitle effect description segment corresponding to the subtitle material segment, the method further includes:

invoking a description segment generation model to process subtitle content in the first video and the dynamic effect protocol file corresponding to the subtitle dynamic effect, so that the subtitle content is subjected to sentence segmentation processing by a sentence segmentation processing sub-model in the description segment generation model to obtain one or more subtitle text segments, and subtitle effect description segments are generated for the one or more subtitle text segments, respectively, by a description segment generation sub-model in the description segment generation model based on the dynamic effect protocol file.

In an optional implementation, the method further includes:

determining a switched subtitle dynamic effect corresponding to the first video in response to a subtitle dynamic effect switching operation for the first video; and

generating a third video corresponding to the first video based on a dynamic effect protocol file corresponding to the switched subtitle dynamic effect, where the third video includes video content of the first video that presents subtitle text with the switched subtitle dynamic effect.

In an optional implementation, after the generating the second video corresponding to the first video based on the subtitle material segment and the audio segment, the method further includes:

determining whether the subtitle dynamic effect has a motion blur effect in response to an export operation for the second video; and

performing motion blur processing on the second video in response to the subtitle dynamic effect having the motion blur effect.

The present disclosure further provides a video processing apparatus, including:

a first determination module, configured to determine a subtitle dynamic effect corresponding to a first video, where the subtitle dynamic effect has a corresponding dynamic effect protocol file, the dynamic effect protocol file is used to characterize dynamic effect feature information of the subtitle dynamic effect, and the first video includes an audio segment and a subtitle text segment having a correspondence with the audio segment;

a first generation module, configured to generate a subtitle material segment according to the dynamic effect protocol file corresponding to the subtitle dynamic effect and the subtitle text segment, where the subtitle material segment is used to present the subtitle text segment with the subtitle dynamic effect; and

a second generation module, configured to generate a second video corresponding to the first video based on the subtitle material segment and the audio segment.

The present disclosure further provides a computer-readable storage medium, where the computer-readable storage medium stores instructions, and the instructions, when executed by a terminal device, causes the terminal device to implement the above method.

The present disclosure further provides a video processing device, including a memory, a processor, and a computer program stored on the memory and executable on the processor, where the processor, when executing the computer program, implements the above method.

The present disclosure further provides a computer program product, including a computer program/instruction, where the computer program/instruction, when executed by a processor, implements the above method.

### BRIEF DESCRIPTION OF DRAWINGS

The drawings herein, which are incorporated in and constitute a part of this specification, illustrate embodiments consistent with the present disclosure and, together with the description, serve to explain the principles of the present disclosure.

In order to more clearly explain the technical solutions in the embodiments of the present disclosure, the drawings required in describing the embodiments will be briefly introduced below. Obviously, for those of ordinary skill in the art, they may also obtain other drawings according to such drawings without paying any creative effort.

FIG. 1 is a flowchart of a video processing method provided by the present disclosure;

FIG. 2 is a schematic diagram of a track editing interface provided by the present disclosure;

FIG. 3 is a schematic diagram of a video processing procedure provided by the present disclosure;

FIG. 4 is a schematic structural diagram of a video processing apparatus provided by the present disclosure; and

FIG. 5 is a schematic structural diagram of a video processing device provided by the present disclosure.

### DETAILED DESCRIPTION

In order to understand the above objects, features and advantages of the present disclosure more clearly, the solutions of the present disclosure will be further described below. It should be noted that the embodiments of the present disclosure and the features in the embodiments may be combined with each other without conflict.

Many specific details are set forth in the following description to fully understand the present disclosure, but the present disclosure may also be implemented in other ways different from those described herein. Obviously, the described embodiments are part of the embodiments of the present disclosure, but not all of the embodiments.

At present, in the art of video processing, a user may manually edit a subtitle in a video, for example, add different effects (such as a font, a font size, an animation effect, and a sticker) to the subtitle according to a subtitle dynamic effect to complete the editing processing of the subtitle.

However, manually adding effects to the video subtitle often takes a long time, and the efficiency is low.

To this end, the embodiments of the present disclosure provide a video processing method. Specifically, a subtitle dynamic effect corresponding to a first video is determined, where the subtitle dynamic effect has a corresponding dynamic effect protocol file, the dynamic effect protocol file is used to characterize dynamic effect feature information of the subtitle dynamic effect, and the first video includes an audio segment and a subtitle text segment having a correspondence with the audio segment. Then, a subtitle material segment for presenting the subtitle text segment with the subtitle dynamic effect is generated according to the dynamic effect protocol file corresponding to the subtitle dynamic effect and the subtitle text segment. Subsequently, a second video corresponding to the first video is generated based on the subtitle material segment and the audio segment.

In the embodiments of the present disclosure, after the subtitle dynamic effect corresponding to the first video is determined, the subtitle material segment for presenting the subtitle text segment with the subtitle dynamic effect is generated based on the dynamic effect protocol file corresponding to the subtitle dynamic effect and the subtitle text segment, and then the second video is generated. The embodiments of the present disclosure can improve the generation efficiency of the subtitle dynamic effect of the subtitle content, thereby improving the overall editing efficiency of the video.

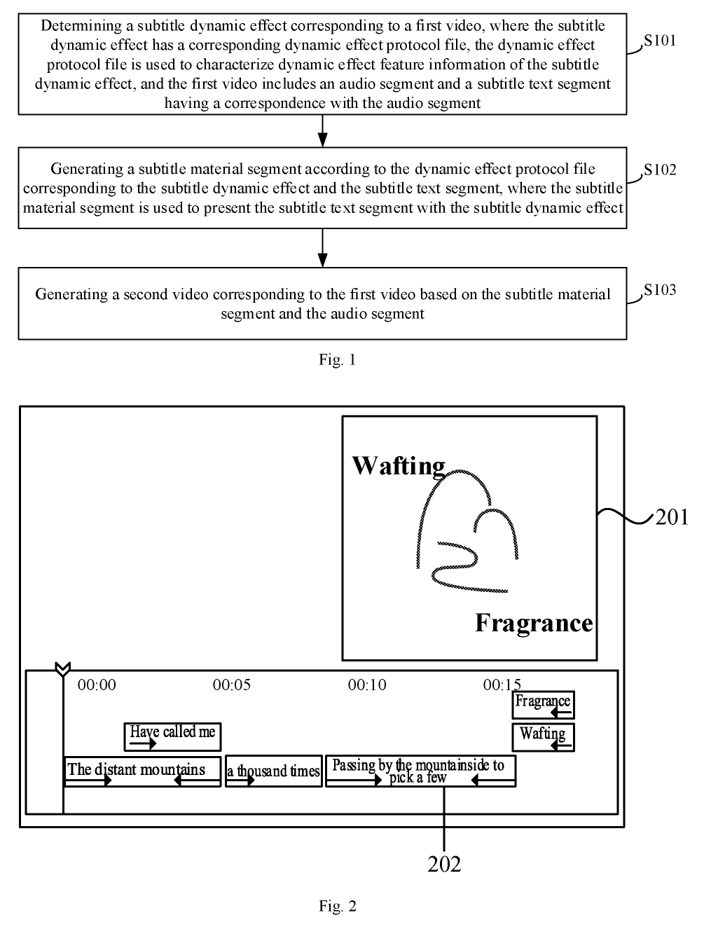

Specifically, the embodiments of the present disclosure provide a video processing method. FIG. 1 is a flowchart of a video processing method provided by the embodiments of the present disclosure, which specifically includes the following steps.

S101: determining a subtitle dynamic effect corresponding to a first video.

The subtitle dynamic effect has a corresponding dynamic effect protocol file, the dynamic effect protocol file is used to characterize dynamic effect feature information of the subtitle dynamic effect, and the first video includes an audio segment and a subtitle text segment having a correspondence with the audio segment.

The video processing method provided by the embodiments of the present disclosure may be applied to a client. Specifically, the client may be deployed on a terminal such as a smart phone, a tablet computer, a desktop computer, etc.

The first video in the embodiments of the present disclosure may be a video that currently needs to undergo video processing. The first video includes multiple audio segments and subtitle text segments, and there is a correspondence between the audio segments and the subtitle text segments. The subtitle text segments are objects of action of the subtitle dynamic effect. The subtitle text segments may be multiple subtitle text segments split from the subtitle content of the first video. Specifically, a model may be used to split the subtitle content corresponding to the first video to obtain the multiple subtitle text segments. The subtitle content corresponding to the first video may be obtained through speech recognition.

The subtitle dynamic effect corresponding to the first video may be one selected by the user from multiple subtitle dynamic effects. The subtitle dynamic effect may be a subtitle presentation style that is pre-configured and has a specific style, specifically, for example, a vintage subtitle style, a dark subtitle style, etc. The subtitle dynamic effect may represent an overall style feature of the subtitle text segment.

In an optional implementation, the subtitle dynamic effect corresponding to the first video may be determined in the following manner: after the first video uploaded by the user is received, when a selection operation for one subtitle dynamic effect of multiple subtitle dynamic effects is received, the selected subtitle dynamic effect is determined as the subtitle dynamic effect corresponding to the first video.

In the embodiments of the present disclosure, there is a correspondence between the subtitle dynamic effect and the dynamic effect protocol file, that is, each subtitle dynamic effect has a corresponding dynamic effect protocol file, and the dynamic effect protocol file is a file that defines rules related to the subtitle dynamic effect. Specifically, the dynamic effect protocol file may be a pre-configured protocol file. The dynamic effect protocol file is used to characterize dynamic effect feature information of the subtitle dynamic effect. The dynamic effect feature information is used to describe various features of the subtitle dynamic effect. Specifically, the dynamic effect feature information may be used to describe dynamic effect elements included in the subtitle dynamic effect and display parameter information corresponding to the dynamic effect elements.

The dynamic effect elements are basic units that constitute a subtitle effect. Specifically, the dynamic effect elements may include animation, font, color, layout mode, global motion, picture effect, and the like. The above dynamic effect elements each have its corresponding display parameter information, and the display parameter information is used to specify a presentation mode of the corresponding dynamic effect element, that is, the display parameter information may represent how the respective corresponding dynamic effect elements are displayed. Specifically, the display parameter information may include the size, color, proportion, display position, appearance timing, change timing, etc., of the dynamic effect elements. For example, the font size of the subtitle content is No. 2 at a certain moment, and the font size of the subtitle content is No. 4 at the next moment.

In an optional implementation, the subtitle dynamic effect may be generated in the following manner: a designer may select a more popular video according to the popularity of existing videos, split various dynamic effect elements included in respective subtitle dynamic effects from the video, and then assemble the various dynamic effect elements and configure related parameter information using related tools to form multiple subtitle dynamic effects, and further, export dynamic effect protocol files corresponding to the respective subtitle dynamic effects.

S102: generating a subtitle material segment according to the dynamic effect protocol file corresponding to the subtitle dynamic effect and the subtitle text segment.

The subtitle material segment is used to present the subtitle text segment with the subtitle dynamic effect. The subtitle material segment is a subtitle text segment that carries the subtitle dynamic effect.

In an optional implementation, the generating the subtitle material segment according to the dynamic effect protocol file corresponding to the subtitle dynamic effect and the subtitle text segment include: obtaining the respective subtitle text segments included in the first video and the dynamic effect protocol file corresponding to the subtitle dynamic effect, then generating a corresponding subtitle effect description segment for each of the subtitle text segments in the first video based on the dynamic effect protocol file, and then generating the subtitle material segment corresponding to the subtitle text segment based on the subtitle effect description segment.

The subtitle text segment may be multiple partial text segments with a time series obtained by performing sentence segmentation processing on the subtitle content corresponding to the first video. Specifically, the subtitle text segment may be a sentence, a phrase, a word, etc., in the subtitle content. For example, the subtitle content is "today is sunny", and the subtitle text segments may be two text segments: "today" and "sunny".

The obtaining the dynamic effect protocol file corresponding to the subtitle dynamic effect may include: when receiving a selection operation for any one of the subtitle dynamic effects, determining the selected subtitle dynamic effect as the subtitle dynamic effect corresponding to the first video, and obtaining the dynamic effect protocol file corresponding to the subtitle dynamic effect from a database corresponding to the subtitle dynamic effect. The database corresponding to the subtitle dynamic effect is used to store dynamic effect protocol files corresponding to the respective subtitle dynamic effects.

There is a correspondence between the subtitle text segment and the subtitle effect description segment, and the subtitle effect description segment is used to describe the subtitle effect corresponding to the corresponding subtitle text segment. The subtitle effect description segment may be generated based on the dynamic effect element defined in the dynamic effect protocol file and the display parameter information corresponding to the dynamic effect element defined in the dynamic effect protocol file.

In an optional implementation, a description segment generation model may be used to generate the subtitle effect description segment corresponding to the subtitle text segment based on the subtitle content and the dynamic effect protocol file. Specifically, the description segment generation model is invoked, the subtitle content of the first video and the dynamic effect protocol file of the subtitle dynamic effect are input into the description segment generation model, the sentence segmentation processing is performed on the subtitle content based on the sentence segmentation processing sub-model in the description segment generation model to obtain multiple subtitle text segments, and the corresponding subtitle effect description segment is generated for each of the multiple subtitle text segments based on the dynamic effect protocol file by the description segment generation sub-model in the description segment generation model. The description segment generation model includes a sentence segmentation processing sub-model and a description segment generation sub-model.

In practical applications, the specific execution logic of generating the subtitle effect description segment corresponding to the subtitle text segment according to the dynamic effect protocol file corresponding to the subtitle dynamic effect and the subtitle text segment may be implemented on a client or a server.

In an optional implementation, after the subtitle effect description segments respectively corresponding to the multiple subtitle text segments are generated, a subtitle effect description file corresponding to the first video may also be formed based on the multiple subtitle effect description segments and the subtitle text segments respectively corresponding to the multiple subtitle effect description segments. The subtitle effect description file is a file used to indicate how the subtitle text segment presents the subtitle effect, and the subtitle effect description file includes the subtitle text segment and the subtitle effect description segment having a correspondence with the subtitle text segment.

S103: generating a second video corresponding to the first video based on the subtitle material segment and the audio segment.

The second video includes the video content of the first video that presents the subtitle content with the subtitle dynamic effect. The subtitle content with the subtitle dynamic effect included in the second video is the subtitle content that has been subjected to the subtitle dynamic effect processing, that is, the second video includes not only the video content of the first video, but also the subtitle content with the subtitle dynamic effect.

In an optional implementation, after the second video is generated based on the subtitle material segment for presenting the subtitle text segment and the audio segment corresponding to the subtitle text segment, the second video may also be displayed in a video preview window of a track editing interface, so that the user may view the display effect of the subtitle dynamic effect in the video, thereby improving the editing experience of the user.

The track editing interface may be an operating interface in video editing software, and the track editing interface is used to display tracks such as a video track, an audio track, and a subtitle track. The video preview window displayed on the track editing interface is used to preview the video after the video editing processing.

FIG. 2 is a schematic diagram of a track editing interface provided by the embodiments of the present disclosure. A second video corresponding to a first video is displayed in a video preview window 201 on the track editing interface. The second video includes video content of the first video that presents subtitle content with a subtitle dynamic effect.

In practical applications, the specific implementation logic of generating the second video based on the subtitle material segment for presenting the subtitle text segment and the audio segment corresponding to the subtitle text segment may be completed on a client or a server.

In an application scenario, a server may be used to generate the second video corresponding to the first video. Specifically, a subtitle dynamic effect generation request is sent to the server, where the subtitle dynamic effect generation request is used to generate a corresponding second video for the first video. Specifically, after the subtitle dynamic effect corresponding to the first video is determined, the subtitle text segment of the first video and the dynamic effect protocol file corresponding to the subtitle dynamic effect are obtained, and then the subtitle dynamic effect generation request carrying the subtitle text segment and the dynamic effect protocol file is sent to the server.

Then, after receiving the subtitle dynamic effect generation request, the server obtains the subtitle text segment and the dynamic effect protocol file, generates a subtitle effect description segment corresponding to the subtitle text segment based on the subtitle text segment and the dynamic effect protocol file, and returns the subtitle effect description segment to the client. Then, after receiving the subtitle effect description segment returned by the server, the subtitle material segment is generated based on the subtitle effect description segment, then the second video is generated based on the subtitle material segment and the audio segment, and the second video is displayed in the video preview window of the track editing interface.

In the video processing method provided by the embodiments of the present disclosure, first, a subtitle dynamic effect corresponding to a first video is determined, where the subtitle dynamic effect has a corresponding dynamic effect protocol file, the dynamic effect protocol file is used to characterize dynamic effect feature information of the subtitle dynamic effect, and the first video includes an audio segment and a subtitle text segment having a correspondence with the audio segment. Then, a subtitle material segment for presenting the subtitle text segment with the subtitle dynamic effect is generated according to the dynamic effect protocol file corresponding to the subtitle dynamic effect and the subtitle text segment. Subsequently, a second video corresponding to the first video is generated based on the subtitle material segment and the audio segment.

In the embodiments of the present disclosure, after the subtitle dynamic effect corresponding to the first video is determined, the subtitle material segment for presenting the subtitle text segment with the subtitle dynamic effect is generated based on the dynamic effect protocol file corresponding to the subtitle dynamic effect and the subtitle text segment, and then the second video is generated. The embodiments of the present disclosure may improve the generation efficiency of the subtitle dynamic effect of the subtitle content, thereby improving the overall editing efficiency of the video.

In an optional implementation, after the second video corresponding to the first video is displayed in the video preview window on the track editing interface, one or more subtitle material segments may also be displayed on the subtitle track on the track editing interface, that is, the subtitle text segments that have been subjected to the subtitle dynamic effect processing are displayed on the track editing interface, so as to facilitate the subsequent adjustment of the subtitle effects of the subtitle material segments by the user, thereby improving the editing efficiency.

In an optional implementation, the one or more subtitle material segments are displayed on the subtitle track on the track editing interface, the subtitle material segments may carry an action time identification of the subtitle dynamic effect, and the action time identification is used to identify the action time of the subtitle dynamic effect. Specifically, the action time identification may be identified by an arrow. The longer the arrow, the longer the action time of the subtitle dynamic effect.

As shown in FIG. 2, multiple subtitle tracks are displayed on the track editing interface, and the subtitle material segment on each subtitle track carries an action time identification of a corresponding subtitle dynamic effect. For example, the subtitle material segment 202 carries an action time identification of a subtitle dynamic effect.

In another optional implementation, one or more subtitle material segments are displayed on the subtitle track on the track editing interface, and the subtitle material segments may carry an identification of a dynamic effect element included in the subtitle dynamic effect.

In an optional implementation, because the second video includes the subtitle content with the subtitle dynamic effect, and presentation of the subtitle content with the subtitle dynamic effect requires the support of corresponding resources, when the corresponding subtitle material segment is generated based on the subtitle effect description segment, the corresponding dependent resource also needs to be obtained. For example, for a subtitle dynamic effect in which a unique font is set for a subtitle, without a dependent resource corresponding to the unique font, the effect of the unique font cannot be displayed for the subtitle.

Specifically, after the subtitle effect description segment is generated, the subtitle effect description segment is parsed to determine the dependent resource of the subtitle effect description segment, and the dependent resource is obtained. After the dependent resource is obtained, the subtitle material segment is generated based on the subtitle effect description segment and the dependent resource.

In practical applications, after the dependent resource of the subtitle effect description segment is determined, it may first be determined whether the dependent resource exists locally. If the dependent resource exists locally, the subtitle material segment may be generated based on the subtitle effect description segment and the dependent resource without obtaining the dependent resource. If the dependent resource does not exist locally, a request for obtaining the dependent resource may be sent to the server, so as to obtain the dependent resource.

In practical applications, the subtitle dynamic effect may have a motion blur effect. Because the application with the motion blur effect requires consumption of more performance, in the embodiments of the present disclosure, when an export operation is triggered for the second video corresponding to the first video, a motion blur processing may be performed on the second video, so as to apply the motion blur effect to the second video, thereby reducing the performance consumption. The motion blur effect is used to simulate the blurring phenomenon generated when an object moves fast, and the application of the motion blur effect may ensure that the dynamic effect of the application object is more real and natural.

Specifically, in the process of displaying the second video corresponding to the first video in the video preview window of the track editing interface, when the export operation for the second video is received, it is determined whether the subtitle dynamic effect has the motion blur effect. If the subtitle dynamic effect has the motion blur effect, the motion blur processing is performed on the second video, and the second video is exported and published based on the processed second video. The export operation for the second video may include a trigger operation for an export control on the track editing interface.

By performing the motion blur effect processing on the second video, it may be ensured that the effect subtitle in the subtitle effect video is more real and natural.

After the second video corresponding to the first video is displayed in the video preview window of the track editing interface, in order to facilitate the adjustment of the subtitle dynamic effect by the user, meet the personalized needs of the user, and further improve the editing experience of the user, the embodiments of the present disclosure may further support a subtitle dynamic effect switching operation for the first video.

Specifically, when a subtitle dynamic effect switching operation for the first video is received, a switched subtitle dynamic effect corresponding to the first video is determined, where the subtitle dynamic effect switching operation for the first video may include trigger operations such as clicking and long pressing on a dynamic effect switching control on the track editing interface.

In an optional implementation, after the switched subtitle dynamic effect corresponding to the first video is determined, a switched subtitle material segment may be generated based on the dynamic effect protocol file corresponding to the switched subtitle dynamic effect and the subtitle text segment in the first video, and then a third video corresponding to the first video is generated based on the subtitle material segment and the audio segment in the first video. The third video includes the video content of the first video that presents the subtitle content with the switched subtitle dynamic effect, that is, the third video displays not only the video content of the first video, but also the subtitle content with the switched subtitle dynamic effect.

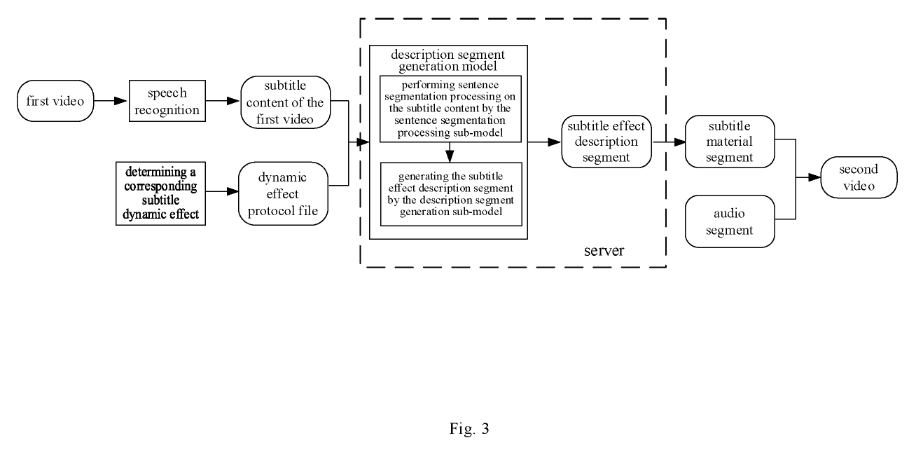

In order to facilitate understanding of the content of the embodiments of the present disclosure, the present disclosure further provides a schematic diagram of a video processing procedure. FIG. 3 is a schematic diagram of a video processing procedure provided by the embodiments of the present disclosure.

In an optional implementation, after the first video is received, when a trigger operation for a certain subtitle dynamic effect is received, the subtitle dynamic effect is determined as the subtitle dynamic effect corresponding to the first video, where the subtitle dynamic effect has a corresponding dynamic effect protocol file, and the dynamic effect protocol file is used to characterize the dynamic effect feature information of the subtitle dynamic effect. Specifically, the subtitle dynamic effect information defines the dynamic effect element included in the subtitle dynamic effect and the display parameter information corresponding to the dynamic effect element.

After the subtitle dynamic effect corresponding to the first video is determined, a speech recognition tool is used to obtain the subtitle content of the first video, and the dynamic effect protocol file is obtained based on the subtitle dynamic effect; and a subtitle dynamic effect generation request carrying the subtitle content and the dynamic effect protocol file is sent to the server.

In an optional implementation, after receiving the subtitle dynamic effect generation request, the server invokes the description segment generation model to generate the subtitle effect description segment corresponding to the subtitle text segment included in the first video based on the subtitle content and the dynamic effect protocol file. Specifically, the subtitle content and the dynamic effect protocol file are input into the description segment generation model, the sentence segmentation processing is performed on the subtitle content based on the sentence segmentation processing sub-model in the description segment generation model to determine one or more subtitle text segments, and the corresponding subtitle effect description segment is generated for each of the multiple subtitle text segments based on the dynamic effect protocol file by the description segment generation sub-model in the description segment generation model, and then the subtitle effect description file corresponding to the first video is constructed based on the multiple subtitle text segments and the subtitle effect description segments respectively corresponding to the multiple subtitle text segments, and then the subtitle effect description file is returned.

After the subtitle effect description file corresponding to the first video is obtained from the server, the subtitle material segment corresponding to each of the subtitle text segments is generated based on the subtitle effect description file, and then the second video corresponding to the first video is generated based on the subtitle material segment and the audio segment corresponding to the subtitle text segment.

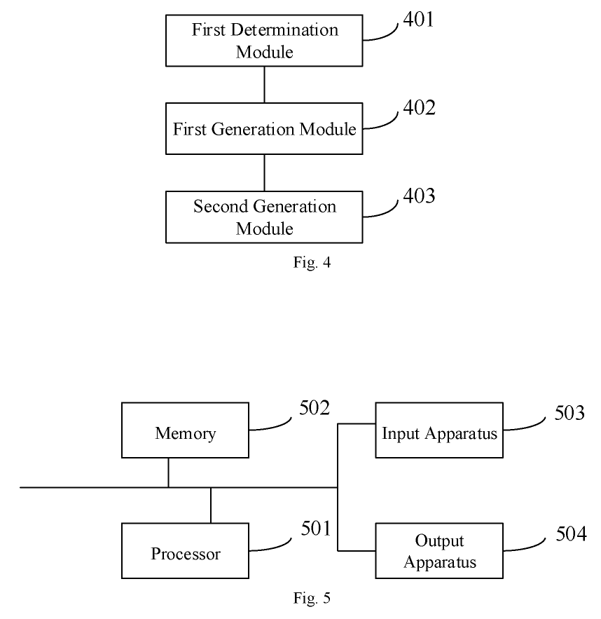

Based on the above method embodiments, the present disclosure further provides a video processing apparatus. FIG. 4 is a schematic structural diagram of a video processing apparatus provided by the embodiments of the present disclosure, and the apparatus includes:

a first determination module 401, configured to determine a subtitle dynamic effect corresponding to a first video, where the subtitle dynamic effect has a corresponding dynamic effect protocol file, the dynamic effect protocol file is used to characterize dynamic effect feature information of the subtitle dynamic effect, and the first video includes an audio segment and a subtitle text segment having a correspondence with the audio segment;

a first generation module 402, configured to generate a subtitle material segment according to the dynamic effect protocol file corresponding to the subtitle dynamic effect and the subtitle text segment, where the subtitle material segment is used to present the subtitle text segment with the subtitle dynamic effect; and

a second generation module 403, configured to generate a second video corresponding to the first video based on the subtitle material segment and the audio segment.

In an optional implementation, the apparatus further includes:

a display module, configured to display the second video in a video preview window of a track editing interface, where the second video presents subtitle content with the subtitle dynamic effect.

In an optional implementation, the apparatus further includes:

a displaying module, configured to display the subtitle material segment on a subtitle track of a track editing interface.

In an optional implementation, the displaying module is further configured to:

display the subtitle material segment on the subtitle track of the track editing interface based on a subtitle effect description segment corresponding to the subtitle material segment, where the subtitle effect description segment is generated for the subtitle text segment corresponding to the subtitle material segment based on the dynamic effect protocol file.

In an optional implementation, the dynamic effect protocol file defines a dynamic effect element included in the subtitle dynamic effect and display parameter information corresponding to the dynamic effect element, and the subtitle effect description segment is generated for the corresponding subtitle text segment based on the dynamic effect element defined in the dynamic effect protocol file and the display parameter information corresponding to the dynamic effect element defined in the dynamic effect protocol file.

In an optional implementation, the apparatus further includes:

a model processing module, configured to invoke a description segment generation model to process subtitle content in the first video and the dynamic effect protocol file corresponding to the subtitle dynamic effect, so that the subtitle content is subjected to sentence segmentation processing by a sentence segmentation processing sub-model in the description segment generation model to obtain one or more subtitle text segments, and subtitle effect description segments are generated for the one or more subtitle text segments, respectively, by a description segment generation sub-model in the description segment generation model based on the dynamic effect protocol file.

In an optional implementation, the apparatus further includes:

a second determination module, configured to determine a switched subtitle dynamic effect corresponding to the first video in response to a subtitle dynamic effect switching operation for the first video; and

a third generation module, configured to generate a third video corresponding to the first video based on a dynamic effect protocol file corresponding to the switched subtitle dynamic effect, where the third video includes video content of the first video that presents a subtitle text with the switched subtitle dynamic effect.

In an optional implementation, the apparatus further includes:

a third determination module, configured to determine whether the subtitle dynamic effect has a motion blur effect in response to an export operation for the second video; and

a video processing module, configured to perform motion blur processing on the second video in response to the subtitle dynamic effect having the motion blur effect.

In the video processing apparatus provided by the embodiments of the present disclosure, first, a subtitle dynamic effect corresponding to a first video is determined, where the subtitle dynamic effect has a corresponding dynamic effect protocol file, the dynamic effect protocol file is used to characterize dynamic effect feature information of the subtitle dynamic effect, and the first video includes an audio segment and a subtitle text segment having a correspondence with the audio segment. Then, a subtitle material segment for presenting the subtitle text segment with the subtitle dynamic effect is generated according to the dynamic effect protocol file corresponding to the subtitle dynamic effect and the subtitle text segment. Subsequently, a second video corresponding to the first video is generated based on the subtitle material segment and the audio segment.

In the embodiments of the present disclosure, after the subtitle dynamic effect corresponding to the first video is determined, the subtitle material segment for presenting the subtitle text segment with the subtitle dynamic effect is generated based on the dynamic effect protocol file corresponding to the subtitle dynamic effect and the subtitle text segment, and then the second video is generated. The embodiments of the present disclosure may improve the generation efficiency of the subtitle dynamic effect of the subtitle content, thereby improving the overall editing efficiency of the video.

In addition to the above methods and apparatuses, the embodiments of the present disclosure further provide a computer-readable storage medium, where the computer-readable storage medium stores instructions, and the instructions, when executed by a terminal device, causes the terminal device to implement the video processing method according to the embodiments of the present disclosure.

The embodiments of the present disclosure further provide a computer program product, including a computer program/instruction, where the computer program/instruction, when executed by a processor, implements the video processing method according to the embodiments of the present disclosure.

In addition, the embodiments of the present disclosure further provide a video processing device, as shown in FIG. 5, including a processor 501, a memory 502, an input apparatus 503, and an output apparatus 504.

The number of processors 501 in the video processing device may be one or more, and one processor is taken as an example in FIG. 5. In some embodiments of the present disclosure, the processor 501, the memory 502, the input apparatus 503, and the output apparatus 504 may be connected through a bus or in other manners, and connection through a bus is taken as an example in FIG. 5.

The memory 502 may be used to store software programs and modules, and the processor 501 executes various functional applications and data processing of the video processing device by running the software programs and modules stored in the memory 502. The memory 502 may mainly include a program storage area and a data storage area, where the program storage area may store an operating system, an application program required by at least one function, etc. In addition, the memory 502 may include a high-speed random access memory or a non-volatile memory, such as at least one magnetic disk storage device, a flash memory device, or other volatile solid-state storage devices. The input apparatus 503 may be used to receive input digital or character information, and generate a signal input related to user settings and function control of the video processing device.

Specifically, in the embodiments, the processor 501 loads the executable file corresponding to the process of one or more application programs into the memory 502 according to the following instructions, and the processor 501 runs the application programs stored in the memory 502, thereby implementing various functions of the above video processing device.

It should be noted that in the present disclosure, relational terms such as "first" and "second" are only used to distinguish one entity or operation from another entity or operation, and do not necessarily require or imply any actual relationship or order between these entities or operations. Moreover, terms "include", "include" or any other variation thereof are intended to cover non-exclusive inclusion, so that a process, a method, an article or a device including a series of elements includes not only those elements, but also other elements not explicitly listed or elements inherent to such process, method, article or device. Without further restrictions, an element defined by the phrase "including a…" does not exclude that there are other identical elements in the process, the method, the article or the device including the element.

The above descriptions are only specific implementations of the present disclosure, so that those skilled in the art may understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments described herein, but rather to the widest scope consistent with the principles and novel features disclosed herein.

1. A video processing method, comprising:
determining a subtitle dynamic effect corresponding to a first video, wherein the subtitle dynamic effect has a corresponding dynamic effect protocol file, the dynamic effect protocol file is used to characterize dynamic effect feature information of the subtitle dynamic effect, and the first video comprises an audio segment and a subtitle text segment having a correspondence with the audio segment;
generating a subtitle material segment according to the dynamic effect protocol file corresponding to the subtitle dynamic effect and the subtitle text segment, wherein the subtitle material segment is used to present the subtitle text segment with the subtitle dynamic effect; and
generating a second video corresponding to the first video based on the subtitle material segment and the audio segment.

2. The video processing method according to claim 1, wherein after the generating the second video corresponding to the first video based on the subtitle material segment and the audio segment, the video processing method further comprises:
displaying the second video in a video preview window of a track editing interface, wherein the second video presents subtitle content with the subtitle dynamic effect.

3. The video processing method according to claim 1, further comprising:
displaying the subtitle material segment on a subtitle track of a track editing interface.

4. The video processing method according to claim 3, wherein the displaying the subtitle material segment on the subtitle track of the track editing interface comprises:
displaying the subtitle material segment on the subtitle track of the track editing interface based on a subtitle effect description segment corresponding to the subtitle material segment, wherein the subtitle effect description segment is generated for the subtitle text segment corresponding to the subtitle material segment based on the dynamic effect protocol file.

5. The video processing method according to claim 4, wherein the dynamic effect protocol file defines a dynamic effect element comprised in the subtitle dynamic effect and display parameter information corresponding to the dynamic effect element, and the subtitle effect description segment is generated for the corresponding subtitle text segment based on the dynamic effect element defined in the dynamic effect protocol file and the display parameter information corresponding to the dynamic effect element defined in the dynamic effect protocol file.

6. The video processing method according to claim 4, wherein before the displaying the subtitle material segment on the subtitle track of the track editing interface based on the subtitle effect description segment corresponding to the subtitle material segment, the video processing method further comprises:
invoking a description segment generation model to process subtitle content in the first video and the dynamic effect protocol file corresponding to the subtitle dynamic effect, so that the subtitle content is subjected to sentence segmentation processing by a sentence segmentation processing sub-model in the description segment generation model to obtain one or more subtitle text segments, and subtitle effect description segments are generated for the one or more subtitle text segments, respectively, by a description segment generation sub-model in the description segment generation model based on the dynamic effect protocol file.

7. The video processing method according to claim 1, further comprising:
determining a switched subtitle dynamic effect corresponding to the first video in response to a subtitle dynamic effect switching operation for the first video; and
generating a third video corresponding to the first video according to a dynamic effect protocol file corresponding to the switched subtitle dynamic effect, wherein the third video comprises video content of the first video that presents subtitle content with the switched subtitle dynamic effect.

8. The video processing method according to claim 1, wherein after the generating the second video corresponding to the first video based on the subtitle material segment and the audio segment, the video processing method further comprises:
determining whether the subtitle dynamic effect has a motion blur effect in response to an export operation for the second video; and
performing motion blur processing on the second video in response to the subtitle dynamic effect having the motion blur effect.

9. A non-transitory computer-readable storage medium, storing instructions, wherein the instructions, when executed by a terminal device, cause the terminal device to implement a video processing method, and the video processing method comprises:
determining a subtitle dynamic effect corresponding to a first video, wherein the subtitle dynamic effect has a corresponding dynamic effect protocol file, the dynamic effect protocol file is used to characterize dynamic effect feature information of the subtitle dynamic effect, and the first video comprises an audio segment and a subtitle text segment having a correspondence with the audio segment;
generating a subtitle material segment according to the dynamic effect protocol file corresponding to the subtitle dynamic effect and the subtitle text segment, wherein the subtitle material segment is used to present the subtitle text segment with the subtitle dynamic effect; and
generating a second video corresponding to the first video based on the subtitle material segment and the audio segment.

10. The non-transitory computer-readable storage medium according to claim 9, wherein after the generating the second video corresponding to the first video based on the subtitle material segment and the audio segment, the video processing method further comprises:
displaying the second video in a video preview window of a track editing interface, wherein the second video presents subtitle content with the subtitle dynamic effect.

11. The non-transitory computer-readable storage medium according to claim 9, wherein the video processing method further comprises:
displaying the subtitle material segment on a subtitle track of a track editing interface.

12. The non-transitory computer-readable storage medium according to claim 11, wherein the displaying the subtitle material segment on the subtitle track of the track editing interface comprises:
displaying the subtitle material segment on the subtitle track of the track editing interface based on a subtitle effect description segment corresponding to the subtitle material segment, wherein the subtitle effect description segment is generated for the subtitle text segment corresponding to the subtitle material segment based on the dynamic effect protocol file.

13. A video processing device, comprising a memory, a processor, and a computer program stored on the memory and executable on the processor, wherein the processor, when executing the computer program, implements a video processing method, and the video processing method comprises:
determining a subtitle dynamic effect corresponding to a first video, wherein the subtitle dynamic effect has a corresponding dynamic effect protocol file, the dynamic effect protocol file is used to characterize dynamic effect feature information of the subtitle dynamic effect, and the first video comprises an audio segment and a subtitle text segment having a correspondence with the audio segment;
generating a subtitle material segment according to the dynamic effect protocol file corresponding to the subtitle dynamic effect and the subtitle text segment, wherein the subtitle material segment is used to present the subtitle text segment with the subtitle dynamic effect; and
generating a second video corresponding to the first video based on the subtitle material segment and the audio segment.

14. The video processing device according to claim 13, wherein after the generating the second video corresponding to the first video based on the subtitle material segment and the audio segment, the video processing method further comprises:
displaying the second video in a video preview window of a track editing interface, wherein the second video presents subtitle content with the subtitle dynamic effect.

15. The video processing device according to claim 13, wherein the video processing method further comprises:
displaying the subtitle material segment on a subtitle track of a track editing interface.

16. The video processing device according to claim 15, wherein the displaying the subtitle material segment on the subtitle track of the track editing interface comprises:
displaying the subtitle material segment on the subtitle track of the track editing interface based on a subtitle effect description segment corresponding to the subtitle material segment, wherein the subtitle effect description segment is generated for the subtitle text segment corresponding to the subtitle material segment based on the dynamic effect protocol file.

17. The video processing device according to claim 16, wherein the dynamic effect protocol file defines a dynamic effect element comprised in the subtitle dynamic effect and display parameter information corresponding to the dynamic effect element, and the subtitle effect description segment is generated for the corresponding subtitle text segment based on the dynamic effect element defined in the dynamic effect protocol file and the display parameter information corresponding to the dynamic effect element defined in the dynamic effect protocol file.

18. The video processing device according to claim 16, wherein before the displaying the subtitle material segment on the subtitle track of the track editing interface based on the subtitle effect description segment corresponding to the subtitle material segment, the video processing method further comprises:
invoking a description segment generation model to process subtitle content in the first video and the dynamic effect protocol file corresponding to the subtitle dynamic effect, so that the subtitle content is subjected to sentence segmentation processing by a sentence segmentation processing sub-model in the description segment generation model to obtain one or more subtitle text segments, and subtitle effect description segments are generated for the one or more subtitle text segments, respectively, by a description segment generation sub-model in the description segment generation model based on the dynamic effect protocol file.

19. The video processing device according to claim 13, wherein the video processing method further comprises:
determining a switched subtitle dynamic effect corresponding to the first video in response to a subtitle dynamic effect switching operation for the first video; and
generating a third video corresponding to the first video according to a dynamic effect protocol file corresponding to the switched subtitle dynamic effect, wherein the third video comprises video content of the first video that presents subtitle content with the switched subtitle dynamic effect.

20. The video processing device according to claim 13, wherein after the generating the second video corresponding to the first video based on the subtitle material segment and the audio segment, the video processing method further comprises:
determining whether the subtitle dynamic effect has a motion blur effect in response to an export operation for the second video; and
performing motion blur processing on the second video in response to the subtitle dynamic effect having the motion blur effect.
